(19) United States
(12) Patent Application Publication
(10) Pub. No.: US 2026/0211084 A1
(43) Pub. Date: Jul. 23, 2026

(54) Lidar Device, Motor Vehicle With Lidar Device, and Corresponding Operating Method

(71) Applicant: Bayerische Motoren Werke Aktiengesellschaft, Muenchen (DE)

(72) Inventor: Jonathan FISCHER, Karlsfeld (DE)

(21) Appl. No.: 19/135,842

(22) PCT Filed: Oct. 27, 2023
(86) PCT No.: PCT/EP2023/080063

§ 371 Date: Jun. 5, 2025

(30) Foreign Application Priority Data
Dec. 6, 2022 (DE) 10 2022 132 400.1

(51) Int. Cl. G01S 7/481; G01S 7/00; G01S 17/86; G01S 17/931

(52) U.S. Cl. CPC G01S 7/4814; G01S 7/003; G01S 7/4812; G01S 7/4817; G01S 17/86; G01S 17/931

(57) ABSTRACT

A lidar device, and a motor vehicle equipped with the lidar device, has a laser for emitting a laser beam, an optical system arranged in the beam path for beam formation, and a detector for detecting corresponding laser beam reflections. The optical system has a variable optical element. The lidar device is thus configured to dynamically vary, during operation, at least one inherent beam property of the emitted laser beam via this variable optical element.

### BACKGROUND AND SUMMARY

The present invention relates to a lidar device and a motor vehicle equipped therewith. The invention furthermore relates to a method for operating such a lidar device and such a motor vehicle.

Surroundings and object recognition which is as accurate, reliable, and robust as possible can be useful in a variety of different areas of application, for example, in various industrial applications and in road traffic. There are various challenges in this case, such as changing surroundings, object types, and object distances, so that there is still a need for improvements.

As one application, DE 11 2012 004 255 T5 describes a three-dimensional laser scanner device for capturing three-dimensional geometric data of a scene. The laser scanner device comprises an illumination system here for generating a light beam and for scanning an illumination spot of the light beam through the scene. Furthermore, the laser scanner device comprises a light recognition system having a light detector and an optical system for imaging light which is scattered in the scene or reflected therefrom onto the light recognition system. The light recognition system comprises a controllable filter element for dynamically distinguishing light which is incident from selected areas of the scene. The filter element is controlled here in operation of the scanner device such that only light which is incident from a selected, spatially delimited area around the illumination spot in the scene is conducted to the light detector.

As an application in the traffic sector, EP 2 396 193 B1 describes an optical object capture device for a motor vehicle. It comprises an emitting unit for emitting an emission light beam, which in turn comprises a controllable micromirror, by means of which the emission light beam is pivotable in a pivot direction, and an emission lens. The emission lens is arranged here behind the micromirror and is designed as a concave-convex lens along the pivot direction. A larger aperture angle of the capture device in the pivot direction is thus to be achieved even if the deflection of the micromirror is limited accordingly.

The object of the present invention is to enable improved lidar-based surroundings recognition.

This object is achieved by the subjects of the independent claims. Further possible designs of the invention are disclosed in the dependent claims, the description, and the figures. Features, advantages, and possible designs which are described in the scope of the description for one of the subjects of the independent claims are to be viewed at least analogously as features, advantages, and possible designs of the respective subject matter of the other independent claims and any possible combination of the subjects of the independent claims, possibly in conjunction with one or more of the dependent claims.

The lidar device according to the invention can be embodied or designed in particular for use in a motor vehicle. The present invention can likewise be usable in other areas of application, however. The lidar device according to the invention comprises a laser for emitting a laser beam, an optical unit arranged in the beam path of the laser beam for beamforming of the laser beam, and a detector for detecting laser beam reflections. The optical unit can thus be arranged and designed for forming or setting or adjusting one or more properties of the laser beam. The optical unit can thus comprise, for example, one or more lenses and/or a mirror and/or a conversion element and/or the like. For example, a focus or focal point or area or a divergence and/or a beam profile or beam cross section of the laser beam can be able to be generated or set according to a corresponding specification or design by means of the optical unit. Likewise, for example an imaging optical unit for imaging incoming laser beam reflections on the detector or a light-sensitive detection or sensor surface can also be connected or placed upstream from the detector.

According to the invention, the optical unit for beamforming the emitted laser beam comprises at least one variable optical element. This optical element can thus be adjustable and/or controllable and/or adaptable, for example, directly or by means of a corresponding adjustment device, in particular in an automated or electrical or motorized manner. According to the invention, the lidar device is configured to dynamically vary, thus to change or set, at least one inherent beam property of the emitted laser beam in its operation by means of the variable optical element, thus, for example, by activating or setting or adapting the optical element and/or a mount or adjustment device coupled thereto. Such an inherent beam property can be in this case a property of the laser beam, which is in particular independent from the beam direction, thus an emission or deflection angle of the laser beam. In other words, the inherent beam property can thus be determinable locally at the emitted laser beam itself independently of surrounding components or a surrounding coordinate system used or the like. Such an inherent beam property can in particular be the beam profile or the divergence or the focus of the emitted laser beam or relate thereto.

Dynamically varying the inherent beam property of the laser beam can in particular mean or comprise that it is changeable at least substantially without interruption during the operation of the lidar device, in particular without manual intervention of a user or operator and/or without structural change of the lidar device.

The present invention is based here on the finding that lidar devices up to this point have not been limited in sensitivity, but rather limited in resolution in their range. Various lidar units are thus available on the market, which can have typical resolutions of, for example, 0.1°×0.1° up to 0.05°×0.05° and therefore can possibly have different effective ranges. A digitally limited or truncated maximum range of, for example, 250 m is sometimes also permanently set. However, the optical components installed therein for the beamforming are solely static components in this case, so that fixed properties of the lidar units accordingly result and a beam characteristic is not dynamically changeable, for example.

Even below the theoretical maximum range, current lidar units are not limited by the detector sensitivity in a most unfavorable scenario (worst case), thus, for example, for detecting relatively small and dark objects, but rather by the respective resolution or the respective scanning capacity. Depending on the beam divergence and possibly also the imaging of the beam geometry of the emitted laser beam on the detector or a corresponding detector geometry, the situation typically results for a given laser beam or a given lidar device and a given object that with increasing distance the area of the object is initially larger, then equal in size, and then smaller than the beam cross section of the laser beam and the corresponding imaging on the detector, thus a receiver. As a result, initially, thus at correspondingly lesser distance, multiple individual detections or pixels can therefore result for the object or on the object, at the so-called pixel filling distance precisely one detection or precisely one pixel for the object, and at greater distances at most one pixel or less than one complete pixel for the object. In the latter case, if the object thus does not fill up the entire cross section of the emitted laser beam, this can result in a significant worsening of the signal-to-noise ratio so that stable object detection is then possibly no longer possible. This can be nonproblematic or irrelevant for sufficiently large objects, however, in practice smaller objects are frequently to be detected. Due to the explained restrictions, this is only possible reliably and stably using conventional static lidar units up to a relatively limited distance or range, although the lidar and sensor technology as such would permit longer detection ranges.

The present invention enables, due to the flexible variability of the at least one inherent beam property, a corresponding adaptation of the emitted laser beam, and therefore by means of a single lidar device, an accurate, flexible, and robust or stable detection of even relatively small objects at different distances. In particular, this is possible both for distances which are a corresponding range or detection limit of conventional lidar units, and for distances which are greater than this range or detection limit. An application spectrum of lidar devices can therefore be enlarged in an effective and efficient manner and, for example, improved reliability can be achieved depending on the application. The latter can be enabled, for example, by earlier detection of even relatively small objects and/or in that to detect a relatively small object at relatively long distance by corresponding adaptation of the focal point or the focal length, in particular the beam cross section in the area of the object to be detected, a lower emission or laser power is used, thus can be sufficient than with conventional lidar units, without a signal-to-noise ratio which is excessively poor thus resulting, as would be the case with conventional lidar units. This is the case since due to the reduced beam cross section, at least a larger proportion of the laser beam or the corresponding photons is reflected from the respective object to be detected itself and not radiated past it and then reflected by other objects or a background.

The variation of the at least one inherent beam property of the emitted laser beam by means of the variable optical element in the beam path of the laser in this case represents a solution which is typically much more cost-effective and saves much more installation space than, for example, the use of two or more different static lidar devices having different, but static optical units or beam properties.

In one possible design of the present invention, the lidar device is configured to vary, as the inherent beam property of the emitted laser beam, its divergence—or the distance of the focal point of the laser beam of the lidar device, which is related thereto—and/or the beam profile, thus the beam form or the beam cross section, of the emitted laser beam. The emitted laser beam can therefore be adapted particularly easily and effectively for scanning and detecting objects of different sizes and/or objects at different distances. Thus, for example, a reduced beam cross section can be achieved or set at a greater distance by a reduced divergence, which in turn can enable a more robust detection of smaller objects at greater distances. A change of a form of the beam cross section or beam profile can enable, for example, optimization for detecting primarily horizontally or primarily vertically extended objects. Particularly reliable, robust, and long-range detection of different objects can thus also be flexibly enabled or improved with respect to a range or detection limit at given minimal signal-to-noise ratio.

In a further possible design of the present invention, the variable optical element is movably mounted, wherein the at least one inherent beam property is variable by corresponding displacement of the optical element. The lidar device can comprise, for example, a corresponding positioning motor and/or a magnetic mount or arrangement, for example, having a coil surrounding the optical element, and/or the like for displacing, thus moving the optical element. The optical element can thus in particular be displaceable electrically or in an electrically controlled manner. This can enable particularly accurate or particularly accurately controllable displacement. In particular, the optical element can be movably mounted, thus displaceable, in the beam direction or beam propagation direction of the laser beam, thus, for example, along or in the direction of an optical axis of the optical unit or the variable optical element. The at least one inherent beam property can be varied particularly easily by the movement or displacement proposed here, thus a physical position change of the variable optical element, and therefore the present invention can be implementable comparatively cost-effectively and using conventional, easily available components.

In a further possible design of the present invention, the variable optical element for varying the at least one inherent beam property of the emitted laser beam is electrically changeable in its shape and/or at least one optical property. Such an optical property can be, for example, an index of refraction or the like. This can be variable, thus settable electrically, thus, for example, by applying an electrical field or an electrical voltage, depending on the design or material selection of the optical element. In the design proposed here, the variable optical element can be designed, for example, as a liquid or gel-type lens or the like. A shell which comprises the liquid or gel-type material of the lens can then be electrically movable or changeable in its shape or, for example, in its mechanical tension or tautness or the like, for example.

The material of the optical element can, for example, also comprise magnetic or metallic particles, for example, thus contain them and therefore react to applied magnetic and/or electrical fields, in particular with a movement or shape change.

The lidar device can be implementable particularly compactly by the design of the present invention proposed here. Moreover, for example, a particularly accurate and/or particularly flexible setting of the variable optical element can be implemented by corresponding complex electrical and/or magnetic field configurations. Complex freeforms of the optical element can thus be implementable, for example, by which, for example, the beam profile can accordingly be settable flexibly and compactly. Therefore, the inherent beam property can thus also be varied flexibly and complexly accordingly or a simultaneous or independent variation of multiple inherent beam properties of the laser beam can be enabled.

In a further possible design of the present invention, it is provided that the variable optical element is or comprises a lens. The control, thus, for example, movement or displacement, of such a lens can possibly be possible more easily and/or precisely or robustly than, for example, a precise and reliable adjustment or shape change of a mirror. In particular, a variable or adjustable lens can presently typically be implementable more cost-effectively than, for example, a variation of the inherent beam property by means of a mirror accurately settable correspondingly in its shape. The use of such a mirror changeable in its shape in a controlled manner as a variable optical element, thus for varying the at least one inherent beam property of the emitted laser beam, would likewise be possible as alternative or additional design options of the present invention, however-at least if suitable hardware is available.

The present invention also relates to a motor vehicle which comprises the lidar device according to the invention for surroundings capture, thus for detecting objects in the respective surroundings of the motor vehicle. The motor vehicle according to the invention can be in particular the motor vehicle mentioned in conjunction with the lidar device according to the invention or can correspond thereto. The application or use of the lidar device according to the invention in a motor vehicle can be particularly useful since a variety of different situations and surroundings configurations can occur in traffic events in which different objects, in particular objects of different sizes, are to be detected at different distances. Since this is enabled or assisted by the lidar device according to the invention, particularly reliable and accurate surroundings recognition and therefore ultimately correspondingly improve safety when driving the motor vehicle according to the invention or in general in traffic events can be enabled.

The present invention also relates to a method for operating the lidar device according to the invention and/or the motor vehicle according to the invention. In this case, in operation of the lidar device, its variable optical element or its variable optical elements and/or an adjustment device coupled thereto are automatically actuated and the at least one inherent beam property of the laser being emitted by the lidar device is thus varied. Further sequences, measures, or procedures mentioned in conjunction with the lidar device according to the invention and/or the motor vehicle according to the invention can form further, possibly optional method steps of the method according to the invention.

In a possible refinement of the present invention, the at least one inherent beam property is automatically set adapted to the situation in each case, thus in each situation matched thereto in each case. The variable optical element or the corresponding adjustment device is thus actuated or set adapted to the situation in each case here. This situation-adapted setting or adjustment takes place depending on a respective current velocity of the motor vehicle equipped with the lidar device and/or depending on captured data from other sources, which describe a respective surroundings situation, or depending on a corresponding surroundings classification, in particular based on such data.

Such other data sources can be or comprise, for example, surroundings data previously generated, in particular during the respective current journey of the motor vehicle on the respective current route section, for example, a surroundings recognition device of the motor vehicle, which semantically describe the respective surroundings, and/or other sensors and/or map data and/or a weather information service and/or other vehicles or road users and/or a traffic monitoring infrastructure or traffic guidance infrastructure and/or a vehicle-external central server device, thus, for example, a backend or a cloud server, and/or the like. Corresponding data from external data sources can be captured, for example, via a respective car2X data connection and/or via a mobile wireless connection and/or via a WLAN connection and/or the like.

For example, a journey of the motor vehicle on a freeway, in particular at least at a predetermined minimum velocity, for example, at least 80 km/h or at least 100 km/h or the like, with free vision or traffic density lying below a predetermined threshold value and/or a predetermined minimum size of an obstacle-free free range lying ahead in the direction of travel, could be provided here as a situation. Such a situation can be relatively well predictable or assessable, for example, with respect to an occurrence of obstacles in a detection range of the lidar device and/or with respect to a laser power usable without disturbance and/or the like. In such a situation, it can be provided or desired that relatively small objects are detected at the greatest possible distance. To enable or assist this, the variable optical element can be set, adjusted, or adapted such that a corresponding focal point or focal area of the emitted laser beam which is far away or lies far ahead in the direction of travel results as an inherent beam property of the emitted laser beam.

In comparison thereto, in another situation a lower velocity of the motor vehicle and/or a higher traffic density in the surroundings of the motor vehicle can be provided. This can be the case, for example, if the motor vehicle is located in an inter-urban area. In such a situation, a detection of objects at correspondingly long distances can be less relevant and instead a detection of objects at close range or at shorter distances can be more relevant than in the situation described first. Likewise, in such a situation there can be an increased hazard or probability of blending or disturbance or other impairment of other road users or equipment in the surroundings of the motor vehicle due to the emitted laser beam. Accordingly, in such a situation, for example, the optical element can be actuated, set, or adapted such that a focal point or focus area of the emitted laser beam located closer to the motor vehicle or the lidar device results as an inherent beam property.

These situations are to be understood as examples here, but illustrate that a corresponding optimization for different situations can be enabled by a corresponding situation-adapted variation of the emitted laser beam of the lidar device.

In a possible refinement of the present invention, the lidar device is used, thus operated, in a motor vehicle to detect objects in the surroundings lying ahead of the motor vehicle, in particular forward in the vehicle longitudinal direction or in the direction of travel in each case. In situations in which the respective surroundings are known or can be classified with less than a predetermined minimum accuracy and/or minimum confidence, the power of the laser of the lidar device can be increased for surroundings scanning, thus for object detection in a predefined close range starting from the motor vehicle or the lidar device with increasing distance, as long as no obstacle is detected, thus, for example, at least no object relevant for the safe vehicle control. Expressed descriptively, the lidar device or the surroundings scanning can thus accordingly advance cautiously at greater distances as long as no objects are detected. Blending, interference, or other impairment of other road users or equipment in the surroundings of the motor vehicle can thus at least be limited. At the same time, however, reliable surroundings recognition or object detection is still enabled, since typically lower laser powers are required or are sufficient for detecting objects at shorter distances.

As soon as an object is detected at a certain distance, for example, the laser power provided in this case can also be maintained for surroundings scanning at even greater distances.

The predefined close range can be, for example, a surrounding area adjoining the motor vehicle or the lidar device here, for example, up to a predetermined distance.

Furthermore, it is provided that in corresponding situations outside the close range, thus at greater distances or from a predetermined minimum distance from the motor vehicle or the lidar device, a focus sharpness or focus size of the laser beam is reduced in comparison to the surroundings scanning within the close range. In corresponding situations and distances, a size or hardness or intensity of the focus point or focus area of the emitted laser beam can thus be reduced, in particular below a maximum technically achievable or settable by means of the respective lidar device or in comparison to a focus size or focus sharpness or intensity which is used or set at close range and/or in more accurate and/or better known situations, if this is possible safely there in each case, in particular while maintaining predetermined requirements for ocular safety. Due to this reduced focus size, specific objects which can be detected reliably and robustly within the close range even with larger focus size, thus less sharp focus, can also accordingly be detected reliably and robustly at greater distances. The situation-dependent and distance-dependent change of the focus size proposed here as an inherent beam property of the emitted laser beam can be implemented as described by corresponding actuation, setting, or adaptation of the at least one variable optical element of the lidar device.

In another possible refinement of the present invention, in operation of the lidar device or the motor vehicle, automatically different values of the at least one inherent beam property of the emitted laser beam are regularly set cyclically repeatedly in a predetermined time sequence. In other words, a corresponding sequence of corresponding settings or positions of the variable optical element and/or the corresponding adjustment device is thus accordingly cyclically run through automatically. This can take place in specific or discrete steps from one value or one setting or position to the next or continuously. The automatic variation of the inherent beam property in a predetermined scheme or in a predetermined time sequence proposed here can be particularly simple to implement. At the same time, in particular if the sequence is run through sufficiently rapidly in a manner adapted to the respective intended use or application, in different situations this enables surroundings scanning or object detection using in each case at least one value or one setting or position which is suitable or optimal for the respective situation. This can in particular be achieved without typically more complex or delay-related recognition or classification of the respective situation and therefore particularly easily, reliably, and consistently. Likewise, the automatic variation of the inherent beam property proposed here can be used as a fallback solution after the predetermined sequence. This can be applied, for example, if the respective situation cannot be recognized or classified at all or not with a predetermined minimum confidence or the like. Improved robustness and reliability of the lidar device or of its operation can thus be achieved overall.

Further features of the invention can result from the claims, the figures, and the description of the figures. The features and combinations of features mentioned above in the description and the features and combinations of features shown hereinafter in the description of the figures and/or solely in the figures are usable not only in the respective specified combination, but also in other combinations or alone, without departing from the scope of the invention.

### BRIEF DESCRIPTION OF THE DRAWING

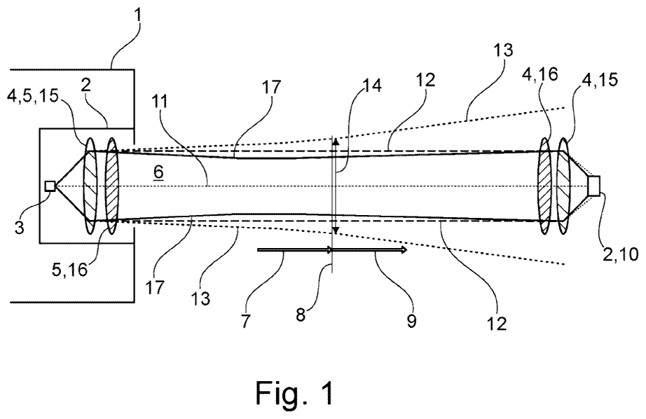

The single FIG. 1 is a schematic overview illustration to illustrate object detection by means of a lidar unit having variable optical unit.

### DETAILED DESCRIPTION OF THE DRAWING

FIG. 1 shows a schematic overview illustration to illustrate dynamic lidar operation. For this purpose, a motor vehicle 1 is indicated here schematically, which is equipped with a lidar unit 2 for surroundings capture. The lidar 2 comprises a laser 3 and an optical unit 4 arranged in front of this laser in the emission or transmission direction here. The optical unit 4 is schematically represented here by a lens 5. A laser beam 6 emitted by the laser 3 can be formed by means of this lens 5 or this optical unit 4.

In operation, the laser beam 6 can thus be emitted by the laser 3, then pass through the optical unit 4, and then be emitted from the motor vehicle 1 or the lidar unit 2 in an emission direction 7 into the surroundings of the motor vehicle 1. The laser beam 6 can strike an object to be detected there and be reflected thereby. For illustration, a corresponding object plane 8 is indicated here, at which this reflection can take place. From there, the laser beam 6 is reflected at least partially in a reception direction 9 back to the lidar 2, in particular to a detector 10 of the lidar 2. To avoid overlaps and therefore for better recognizability, a linear representation is shown here, in which the path of the laser beam 6 is illustrated in a certain manner in its own coordinate system. In practice or in a spatially correct representation, of course, the detector 10 can also be located in or on the lidar unit 2, for example, adjacent to the laser 3. Accordingly, the reception direction 9 would thus really be opposite to the emission direction 7 and extend from the object plane 8 back to the lidar 2.

An optical axis 11 of the optical unit 4 extending in the center of the laser beam 6 is also indicated here for further illustration.

In a theoretically ideal case, the laser beam 6 would extend parallel or uniformly over its entire path, thus have a divergence of zero. This is indicated here by a corresponding ideal beam course 12. In such an ideal case, a specific object could be detected at arbitrary distance with equal accuracy and precision or with the same signal-to-noise ratio. In practice, however, this is not the case. Rather, beam expansion can typically occur. This is illustrated here by a conventional beam course 13. It can be seen clearly here that a corresponding laser beam 6, which is emitted with a corresponding setting of the optical unit 4 or by means of a corresponding conventional static lidar device, has, according to the typical beam course 13, a smaller beam cross section in the object plane 8 than in the area of the optical unit 4 after the reflection on the respective object.

For further illustration, a pixel filling dimension 14 is indicated here at the object plane 8. This is the dimension of an object irradiated by the emitted laser beam 6 which just precisely fills the laser beam 6, thus corresponds to its cross section or cross-sectional dimension. Such an object having the corresponding dimension at the corresponding distance can also be referred to as a pixel filling target. The distance from the lidar unit 2, at which a specific object just has this pixel filling dimension 14 for a given laser beam 6 can limit the effective range thereof in conventional static lidar devices. This can be relevant in practical applications in particular for relatively small objects, such as beverage cans, buckets, tires, or the like. A certain proportion of the laser beam reflections from the respective object can then already radiate past optical unit 4 on the receiver side, so that not all photons reflected from the respective object thus actually can be incident or can be detected in the detector 10. This effect becomes stronger with smaller objects at the same distance or with the same object at a greater distance, so that stable object detection is then no longer possible.

To counter this problem, the beamforming optical unit 4 is designed here as dynamically variably settable. For this purpose, for example, the lens 5 is adjustable here between a first position or first setting 15 and a second position or second setting 16. The position of the lens 5 along the optical axis 11 and/or, for example, a shape and/or an optical property of the lens 5 can be changed here, for example. Such a change can be carried out automatically, for example, cyclically or depending on or adapted to the situation, for example, controlled by the lidar unit 2.

For a corresponding control or operating method, the lidar 2 can comprise, for example, a corresponding control unit or data processing unit. This can be, for example, a correspondingly configured circuit and/or a processing unit having a computer-readable data memory coupled thereto and/or the like here. A corresponding operating or computer program can then be stored in such a data memory, for example, which codes or implements the method steps, measures, or sequences of the corresponding method and/or corresponding control instructions. This operating or computer program can then be executable by means of the processing unit, thus, for example, by means of a microprocessor, microchip, or microcontroller or the like in order to carry out the corresponding method or cause it to be carried out.

The divergence of the emitted laser beam 6 and therefore its focus or its beam cross section at a specific distance can be changed or specified, thus set, for example, by a corresponding dynamic adjustment or adaptation or setting of the optical unit 4 or at least one corresponding variable optical element of the optical unit 4, which is represented by way of example here in the form of the lens 5. A correspondingly adapted beam course 17 is indicated here as an example. They can be seen that the laser beam 6 here according to this exemplary adapted beam course 17 has a smaller beam cross section in comparison to the conventional beam course 13 in the area of the object plane 8. All light reflected from the respective object back to the optical unit 4 can thus be incident or detected in the detector 10. The corresponding object can thus be detected more reliably or, for example, also at a greater distance than by means of the conventional beam course 13. A variety of other adapted beam courses 17 can likewise be set, thus generated, dynamically in operation of the lidar 2 by other settings or adaptations of the optical unit 4 or the variable lens 5.

Therefore a distance-independent pixel filling dimension 14 can be implemented—to a greater extent at least in comparison to conventional static lidar devices—at least over multiple laser pulses emitted in succession with different settings or adaptations of the optical unit 4. In other words, at a given distance the scanning capacity or the resolution of the lidar 2 can thus be improved or can be set as needed in each case or can be maintained by reducing the beam cross section with increasing distance or at least can decrease less strongly or less quickly with increasing distance in comparison to conventional static lidar devices.

The effects and corrections or changes shown can occur both in the vertical and in the horizontal direction.

Overall, the examples described show how a lidar device having movable focus can be implemented.

### LIST OF REFERENCE SIGNS

1 motor vehicle
2 lidar unit
3 laser
4 optical unit
5 lens
6 laser beam
7 emission direction
8 object plane
9 reception direction
10 detector
11 optical axis
12 ideal beam course
13 conventional beam course
14 pixel filling dimension
15 first setting
16 second setting
17 adapted beam course

1.-10. (canceled)

11. A lidar device, comprising:
a laser for emitting a laser beam;
an optical unit arranged in a beam path of the laser beam for beamforming of the emitted laser beam, wherein the optical unit comprises a variable optical element; and
a detector that detects laser beam reflections,
wherein the lidar device is configured to dynamically vary, during operation, at least one inherent beam property of the emitted laser beam via the variable optical element.

12. The lidar device according to claim 11, wherein
the lidar device is configured to vary a divergence and/or a beam profile of the emitted laser beam as the inherent beam property.

13. The lidar device according to claim 11, wherein
the variable optical element is displaceable mounted, and
the at least one inherent beam property is vared by corresponding displacement of the optical element.

14. The lidar device according to claim 13, wherein
the variable optical element is displaceably mounted so as to be movable in a beam direction of the laser beam.

15. The lidar device according to claim 11, wherein
the variable optical element is electrically changeable in shape and/or in at least one optical property to vary the inherent beam property of the emitted laser beam.

16. The lidar device according to claim 11, wherein
the variable optical element comprises a lens.

17. A motor vehicle comprising a lidar device according to claim 11.

18. A method for operating a lidar device, comprising:
operating a laser of the lidar device for emitting a laser beam, wherein an optical unit arranged in a beam path of the laser beam beamforms the emitted laser beam, and a detector detects laser beam reflections; and
automatically actuating, during the operating, a variable optical element and/or an adjustment unit coupled thereto, to dynamically vary at least one inherent beam property of the emitted laser beam.

19. The method according to claim 18, wherein
the at least one inherent beam property is automatically set in a manner adapted to the situation in each case depending on a respective current velocity of a motor vehicle equipped with the lidar device and/or depending on captured data from other data sources, which describe a respective surrounding situation.

20. The method according to claim 18, wherein
the lidar device is operated in a motor vehicle for detecting objects in surroundings lying ahead of the motor vehicle, and
in situations, in which the respective surroundings are classifiable with less than a predetermined minimum accuracy and/or minimum confidence, the method scans:
(i) in a predefined close range starting from the motor vehicle, by increasing a power of the laser with increasing distance as long as no obstacle is detected, and
(ii) outside the close range, by reducing a focus size of the laser beam.

21. The method according to claim 18, wherein
different values of the at least one inherent beam property are regularly cyclically repeatedly set in a predetermined time sequence automatically.
